(19) United States
(12) Patent Application Publication
(10) Pub. No.: US 2026/0148426 A1
(43) Pub. Date: May 28, 2026

(54) NEGATIVE PROMPTING IMAGE GENERATION MODELS WITH ATTENTION COMPOSITION

(71) Applicant: ADOBE INC., SAN JOSE, CA (US)

(72) Inventors: Siavash Khodadadeh, Mountain View, CA (US); Ratheesh Kalarot, San Jose, CA (US); Hareesh Ravi, San Jose, CA (US)

(21) Appl. No.: 18/957,769

(22) Filed: Nov. 24, 2024

(51) Int. Cl. G06T 11/00

(52) U.S. Cl. CPC G06T 11/00; G06T 2200/24

(57) ABSTRACT

A method, apparatus, non-transitory computer readable medium, and system for generating images based on a target prompt and an anchor prompt include obtaining the target prompt the anchor prompt. The target prompt describes a first element, and the anchor prompt describes a second element. A first attention block of an image generation model generates a first attention output based on the target prompt and a second attention block of the image generation model generates a second attention output based on the anchor prompt. The image generation model then generates a synthetic image that depicts the first element and excludes the second element by combining the first attention output and the second attention output

### BACKGROUND

The following relates generally to image processing, and more specifically to image generation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image generation is a type of image processing that involves the creation of synthetic images. Recently, generative artificial intelligence (AI) models have been developed to generate realistic images. One such model is the Denoising Diffusion Probabilistic Model (DDPM). DDPMs generate samples by transforming an initial random noise distribution into a data distribution over a series of time steps. In some cases, a DDPM can be conditioned on a text description, such that the diffusion process generates images that match the text. The strength of the conditioning can be controlled using an approach known as classifier-free guidance (CFG).

### SUMMARY

Embodiments of the present inventive concepts described herein include systems and methods for generating images based on a negative prompt. In other words, the systems and methods can produce images that do not contain an element described by the negative prompt. Embodiments include an image generation model with a first attention block and a second attention block. The first attention block is responsible for including desired features, and the second attention block is responsible for excluding undesired features. The first attention block receives an input, referred to as a query vector, representing an initial or previous generative timestep. Then, the first attention block performs cross attention with the query vector and content features from a target prompt, sometimes referred to herein as a “content prompt.” Similarly, the second attention block receives the same query vector but performs cross-attention with anchor features from an anchor prompt, which describes elements to be excluded from the synthesized image. The output from the second attention block is subtracted from the output of the first attention block, and this combined guidance is used to adjust the query vector before the next generative iteration. In this way, the image generation model can condition the generation process within the attention layers, as opposed to running the full denoising pipeline multiple times, as is done in the conventional classifier-free guidance (CFG) approach.

A method, apparatus, non-transitory computer readable medium, and system for image generation are described. One or more aspects of the method, apparatus, non-transitory computer readable medium, and system include obtaining a target prompt describing a first element and an anchor prompt describing a second element; generating, using a first attention block of an image generation model, a first attention output based on the target prompt; generating, using a second attention block of the image generation model, a second attention output based on the anchor prompt; and generating, using the image generation model, a synthetic image that depicts the first element and excludes the second element by combining the first attention output and the second attention output.

A method, apparatus, non-transitory computer readable medium, and system for image generation are described. One or more aspects of the method, apparatus, non-transitory computer readable medium, and system include obtaining a training set including a target prompt describing a first element and an anchor prompt describing a second element; generating, using a teacher model, a teacher guidance output including a condition term based on the target prompt and an anchor term based on the anchor prompt; and training, using the training data and the teacher guidance output, an image generation model to generate a synthetic image that depicts the first element and excludes the second element.

An apparatus, system, and method for image generation are described. One or more aspects of the apparatus, system, and method include a memory component; a processing device coupled to the memory component, the processing device configured to perform operations comprising: generating, using a first attention block of an image generation model, a first attention output based on a target prompt, wherein the target prompt describes a first element; generating, using a second attention block of the image generation model, a second attention output based on an anchor prompt, wherein the anchor prompt describes a second element; and generating, using the image generation model, a synthetic image that depicts the first element and excludes the second element by combining the first attention output and the second attention output.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of guided latent diffusion model according to aspects of the present disclosure.

FIG. 4 shows an example of U-Net according to aspects of the present disclosure.

FIG. 5 shows an example of first and second attention blocks according to aspects of the present disclosure.

FIG. 6 shows an example of a method a diffusion process according to aspects of the present disclosure.

FIG. 7 shows an example of for providing a custom image to a user according to aspects of the present disclosure.

FIG. 8 shows an example of a method for generating an image that depicts a first element and excludes a second element according to aspects of the present disclosure.

FIG. 9 shows an example of a machine learning training algorithm according to aspects of the present disclosure.

FIG. 10 shows an example of a diffusion training process according to aspects of the present disclosure.

FIG. 11 shows an example of a method for training a machine learning model according to aspects of the present disclosure.

FIG. 12 shows an example of results from a teacher model and an image generation model according to aspects of the present disclosure.

FIG. 13 shows an example of a computing device according to aspects of the present disclosure.

### DETAILED DESCRIPTION

Image generation is frequently used in creative workflows. Historically, users would rely on manual techniques and drawing software to create visual content. The advent of machine learning (ML) has enabled new workflows that automate the image creation process.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention. Generative models in ML are algorithms designed to generate new data samples that resemble a given dataset. Generative models are used in various fields, including image generation. They work by learning patterns, features, and distributions from a dataset and then using this understanding to produce new, original outputs.

Many types of ML architecture are available for image generation. One common architecture is the Generative Adversarial Network (GAN). GANs consist of two networks, a generator and a discriminator, which are trained together. The generator creates images, and the discriminator tries to distinguish between real and generated images. Another approach is the Variational Autoencoder (VAE). VAEs encode input images into a latent space and then decode them to generate new images. This helps in learning the underlying distribution of the data. Convolutional Neural Networks (CNNs) are also used in image generation, especially when integrated into larger models to extract features from images.

More recently, diffusion models have emerged as another class of generative models used for image generation. They work by iteratively denoising a randomly initialized image over a series of steps. During each step, noise is gradually removed based on learned patterns until a clear image emerges. In text-to-image diffusion, the model is guided by a text prompt during the denoising process. This allows the generated image to reflect the content described in the text. The text prompt is encoded into a set of features that condition the diffusion model at each step. This process enables the creation of detailed and complex images based on the input text.

Classifier guidance was an early approach to guide image generation towards a specific class described by a text prompt. This technique used a separate classifier trained to predict the likelihood of an image belonging to a particular class. During generation, the classifier's gradient was used to adjust the generative process by nudging the model towards an output data distribution of images that align with the specified class.

Classifier-free guidance (CFG) addresses these limitations by removing the need for a separate classifier. It directly conditions the generation process on the text prompt. This enables the model to handle more complex and detailed prompts beyond predefined classes. CFG achieves this by running the model once with the prompt and once without it, then combining the results to steer the generation. However, the CFG approach necessitates running the entire denoising pipeline multiple times for each condition, such as text features, image condition features, and anchor prompt features. The denoising pipeline at each generative timestep can include processing features in convolution, attention, residual, conditional, noise prediction, and positional encoding blocks. For example, CFG guidance may be expressed as:

$$Combined Noise = f ( x , n ) + {CFG}_{scale} * [ f ( x , c ) - f ( x , n ) ] \qquad ( 1 )$$

where ƒ denotes parameters of the denoising pipeline, x denotes the current sample, c denotes conditioning, and n denotes the null condition, that is, running the model without features from external prompts. As shown by this approach, ƒ must be run at least twice, and sometimes more to incorporate additional conditions.

CFG also allows for the use of negative prompts, sometimes referred to as anchor prompts. This is done by running the full denoising pipeline described by Equation (1) with the anchor features, denoted as n′, instead of the null condition n. The anchor features describe elements to be excluded from the generated image, and this approach enables the model to guide the generation away from those features.

Student models can be trained to incorporate condition features from a text prompt in a similar way to CFG. These models learn to apply a fixed weighting of the conditioning information during training, enabling them to operate with only one run of the model during inference. For example, a student model fs can be configured to output the equivalent of:

$${f}_{s} ( x , c ) = f ( x , n ) + {CFG}_{scale} * [ f ( x , c ) - f ( x , n ) ] \qquad ( 2 )$$

in a single generative iteration. Here, ƒₛ produces a result similar to the CFG formula without needing to run the model multiple times. However, because they do not run multiple times, conventional student models cannot enable anchor prompting by performing the trick mentioned above, where anchor features, denoted as n′, are used in place of the null condition n. In conventional student models, there is no explicit comparison of conditioned predicted noise and unconditioned predicted noise.

Embodiments of the present disclosure increase image generation efficiency by implementing an image generation model that can incorporate desired content elements and exclude anchor elements within a single generative iteration. This results in a nearly 2× speedup compared to a CFG-based parent model, while retaining the ability to exclude anchor prompts. Embodiments of the image generation model include a first attention block and a second attention block. The first attention block is responsible for including desired features, and the second attention block is responsible for excluding undesired features. The first attention block performs cross attention with a query vector and content features from a target prompt. Similarly, the second attention block receives the same query vector but performs cross-attention with anchor features from an anchor prompt. The output from the second attention block is subtracted from the output of the first attention block, and this combined guidance is used to adjust the query vector before the next generative iteration. In this way, embodiments are able to steer the generation process away from the anchor elements within the attention layers, without running the entire denoising pipeline multiple times.

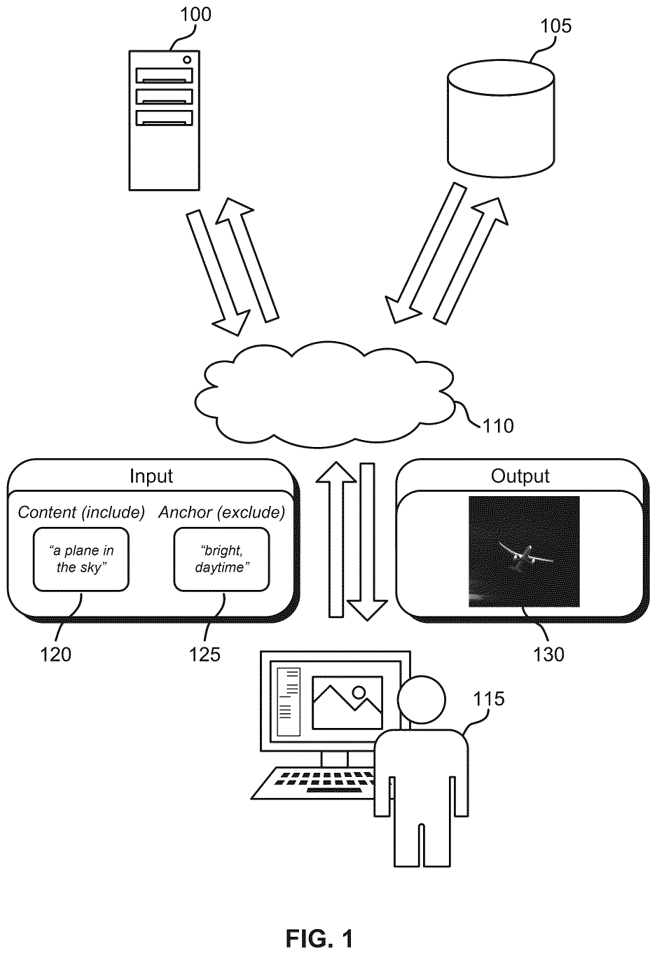

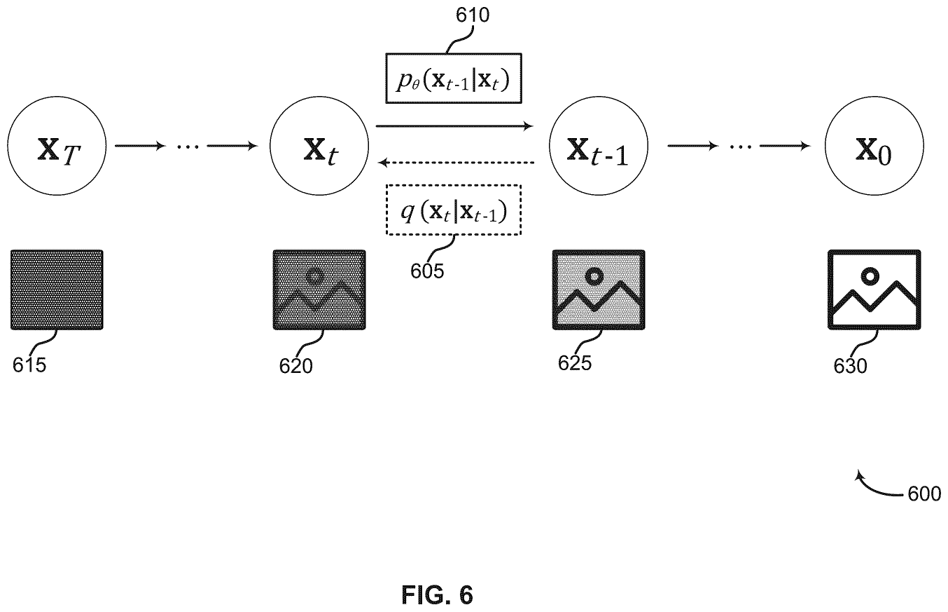

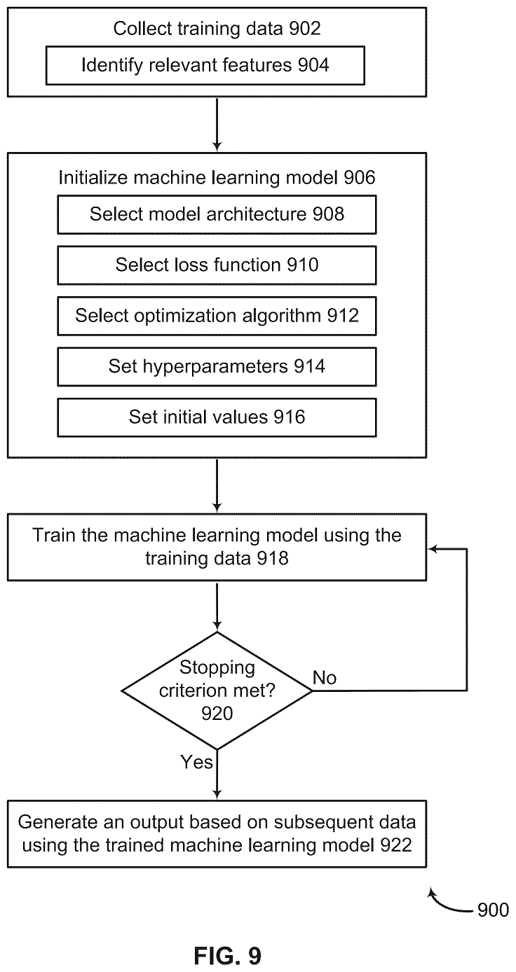

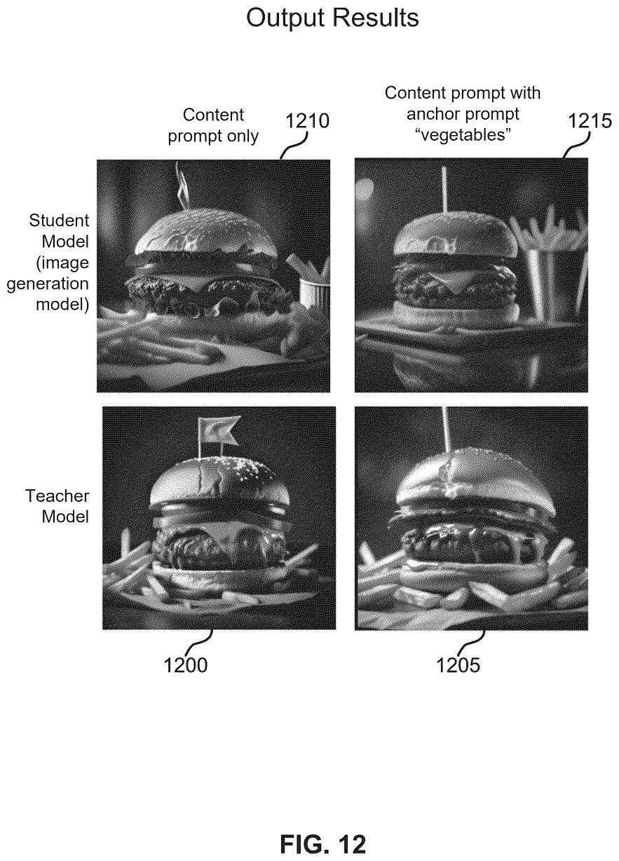

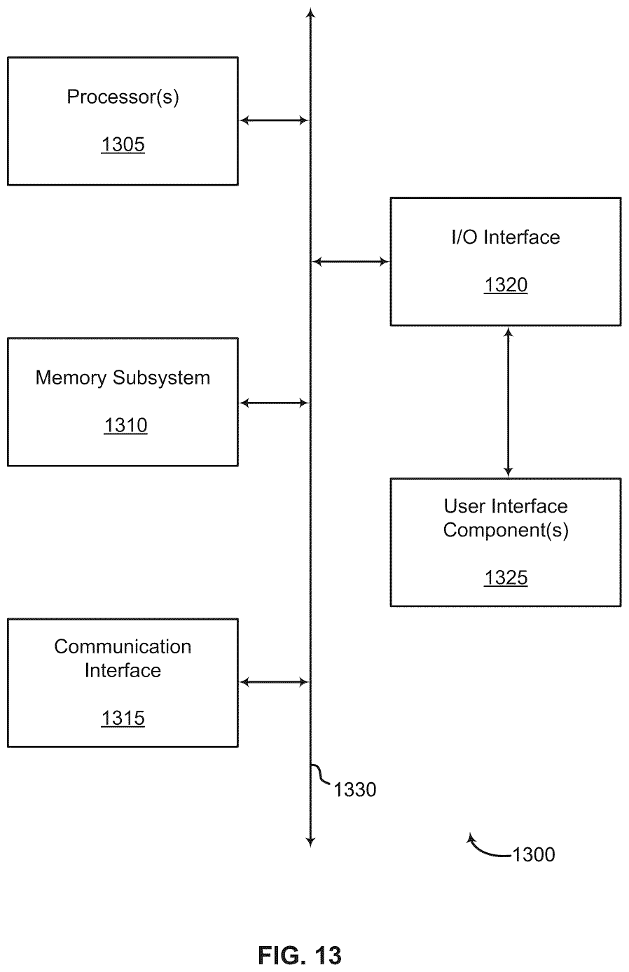

An image processing system is described with reference to FIGS. 1-5. Methods for generating images from target prompts and anchor prompts are described with reference to FIGS. 6-8. Training methods are described with reference to FIGS. 9-11. Results of a teacher model and a student model (e.g., the student model being an equivalent of the image generation model described herein) are discussed with reference to FIG. 12. A computing device configured to implement an image processing apparatus is described with reference to FIG. 13.

### Image Processing System

FIG. 1 shows an example of an image processing system according to aspects of the present disclosure. The example shown includes image processing apparatus 100, database 105, network 110, user 115, target prompt 120, anchor prompt 125, and synthetic image 130.

In this example, user 115 provides inputs including target prompt 120 and anchor prompt 125. The target prompt 120 includes elements the user wishes to generate in an image, and the anchor prompt 125 includes elements the user wishes to be excluded from the image. The image processing apparatus 100 processes target prompt 120 and anchor prompt 125 to generate target features and anchor features, respectively, which are then used to condition the generation of synthetic image 130. Image generation apparatus 100 then provides synthetic image 130 to user 115.

Embodiments of image processing apparatus 100 include components that are implemented on a server. A server provides one or more functions to users linked by way of one or more of available networks, such as network 110. In some cases, the server includes a single microprocessor board, which includes a microprocessor responsible for controlling all aspects of the server. In some cases, a server uses microprocessors and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 stores information used by the image processing system, such as model parameters, embeddings, training data, instructions and code libraries, stock images, previously generated images, and the like. A database is an organized collection of data. For example, database 105 stores data in a specified format known as a schema. A database may be structured as a single database, a distributed database, multiple distributed databases, or an emergency backup database. In some cases, a database controller may manage data storage and processing in database 105. In some cases, user 115 interacts with the database controller. In other cases, the database controller may operate automatically without user interaction.

Network 110 facilitates the transfer of information between image processing apparatus 100, database 105, and user 115. Network 110 may be referred to as a “cloud.” A cloud is a computer network configured to provide on-demand availability of computer system resources, such as data storage and computing power. In some examples, the cloud provides resources without active management by user 115. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User 115 may interact with the image processing system via a user interface. In some embodiments, the user interface may include an audio device, such as an external speaker system, an external display device such as a display screen, or an input device (e.g., remote control device interfaced with the user interface directly or through an IO controller module). In some cases, a user interface may be a graphical user interface (GUI). The user may interact with the GUI to, for example, provide target prompt 120 and anchor prompt 125, and to receive synthetic image 130.

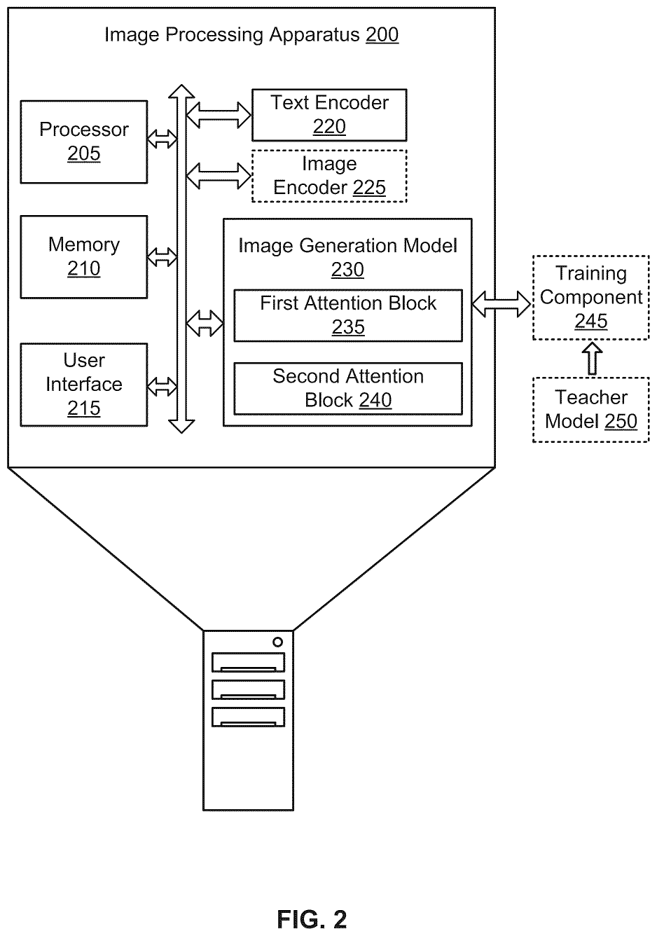

FIG. 2 shows an example of an image processing apparatus 200 according to aspects of the present disclosure. The example shown includes image processing apparatus 200, processor 205, memory 210, user interface 215, text encoder 220, image encoder 225, image generation model 230, training component 245, and teacher model 250. Image processing apparatus 200 is an example of, or includes aspects of, the corresponding element described with reference to FIG. 1.

Processor 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

Memory 210 stores information used by image processing apparatus 200, such as data, instructions executable by processor 205, machine learning model parameters, configurations, and the like. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

User interface 215 enables a user to interact with image processing apparatus 200. In some embodiments, user interface 215 includes an audio device, such as an external speaker system, an external display device such as a display screen, or an input device (e.g., remote control device interfaced with the user interface directly or through an IO controller module). In some cases, a user interface may be a graphical user interface (GUI).

According to some aspects, the image processing apparatus 200, through user interface 215, obtains a target prompt describing a first element and an anchor prompt describing a second element. In some examples, the image processing apparatus 200, through user interface 215, obtains a preliminary prompt, and extracts the target prompt and the anchor prompt from the preliminary prompt.

Text encoder 220 is configured to process an input text to generate a text embedding. According to some aspects, text encoder 220 is configured to encode a target prompt and an anchor prompt to obtain a target text embedding and an anchor text embedding, respectively. Embodiments of text encoder 220 include a transformer-based encoder such as Flan-T5, GPT-3, or the CLIP text encoder.

A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a. The transformer architecture is used in both text encoder 220 and in certain layers of image generation model 230.

Image encoder 225 is configured to process an image to generate image features that can be used to condition the generation process of image generation model 230. For example, a user may prompt the system to borrow a particular style from a reference image, or to generate infilled content for the reference image. Embodiments of image encoder 225 include a convolutional neural network (CNN)-based encoder or a transformer-based encoder such as the CLIP image encoder.

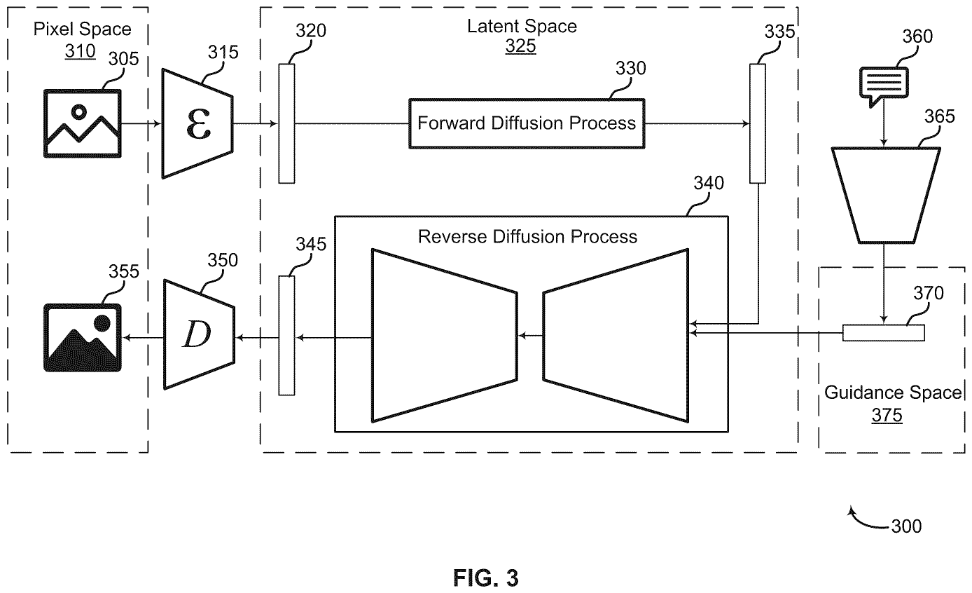

Image generation model 230 generates synthetic images that include elements from a target prompt and exclude elements from an anchor prompt. Embodiments of image generation model 230 include a diffusion model. Additional detail regarding an example diffusion model will be described with reference to FIG. 3.

According to some aspects, image generation model 230 generates, using a first attention block 235, a first attention output based on the target prompt. In some examples, image generation model 230 generates, using a second attention block 240, a second attention output based on the anchor prompt. In some examples, image generation model 230 generates a synthetic image that depicts the first element and excludes the second element by combining the first attention output and the second attention output. In some examples, image generation model 230 obtains a query vector, where the first attention output and the second attention output are generated based on the query vector.

In some examples, image generation model 230 generates a preliminary image, where the first attention output and the second attention output are generated based on the preliminary image. The preliminary image may be a reference image in a creative workflow for example, and the synthetic image may be an inpainted or otherwise generative-based edit of the reference image. In some aspects, the second attention output is based on the target prompt and the anchor prompt. In some examples, image generation model 230 obtains a noise input. In some examples, image generation model 230 generates a guidance output based on the first attention output and the second attention output. In some examples, image generation model 230 denoises the noise input based on the guidance output. In some aspects, the image generation model 230 is trained based on a teacher model 250 that computes a classifier free guidance (CFG) based on a condition term and an anchor term.

Training component 245 trains image generation model 230 during a training phase. The training may include initializing parameters of image generation model 230 from another model (e.g., teacher model 250) comparing a predicted output from image generation model 230 to a ground truth value such as a ground truth image, and then updating the parameters of image generation model 230 based on the comparison.

According to some aspects, training component 245 obtains a training set including a target prompt describing a first element and an anchor prompt describing a second element. In some examples, training component 245 trains, using the training data and the teacher guidance output, an image generation model 230 to generate a synthetic image that depicts the first element and excludes the second element. In some aspects, the training set includes a training image including the first element and excluding the second element. In some examples, training component 245 compares the guidance output to the teacher guidance output. In some examples, training component 245 initializes parameters of the image generation model 230 based on the teacher model 250.

Teacher model 250 is used during the training process of image generation model 230. Teacher model 250 produces ground truth data for training component 245 to use in training image generation model 250. For example, teacher model 250 may generate a ground truth image from a caption, where the caption includes a target prompt, and anchor prompt, or both. In some aspects, the image generation model 230 is initialized based on the teacher model 250. Embodiments of teacher model 250 include a similar architecture to image generation model 230, but unlike image generation model 230, are configured to run the entire denoising pipeline of a U-Net architecture multiple times at a generative timestep in order to implement conditional guidance via the CFG process. In contrast, image generation model 230 runs a subset of the U-Net parameters multiple times to incorporate multiple guidance inputs, for example, from cross-attention block(s), thereby increasing inference speed. According to some aspects, the image generation model 230 of the present embodiments is nearly 2× faster than CFG-based diffusion models.

FIG. 3 shows an example of a guided latent diffusion model 300 according to aspects of the present disclosure. The guided latent diffusion model 300 depicted in FIG. 3 is an example of, or includes aspects of, the image generation model 230 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and fine-tuned jointly with the reverse diffusion process 340.

The reverse diffusion process 340 can also be guided based on a text prompt 360, or another guidance prompt, such as an image, a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340.

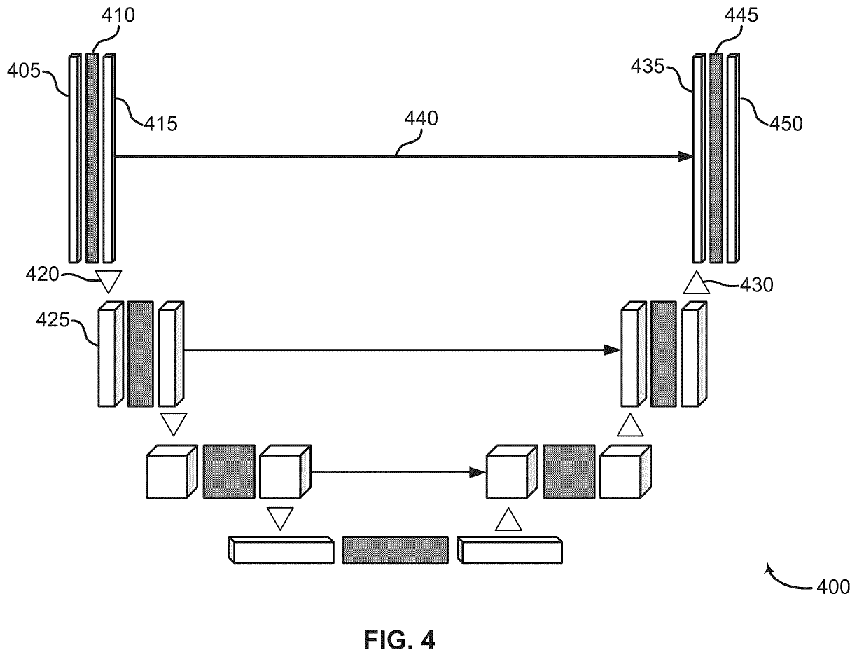

FIG. 4 shows an example of a U-Net 400 according to aspects of the present disclosure. In some examples, U-Net 400 is an example of the component that performs the reverse diffusion process 340 of guided diffusion model 300 described with reference to FIG. 3 and includes architectural elements of the image generation model 230 described with reference to FIG. 2. The U-Net 400 depicted in FIG. 4 is an example of, or includes aspects of, the architecture used within the reverse diffusion process described with reference to FIG. 6.

In some examples, diffusion models are based on a neural network architecture known as a U-Net. The U-Net 400 takes input features 405 having an initial resolution and an initial number of channels and processes the input features 405 using an initial neural network layer 410 (e.g., a convolutional network layer) to produce intermediate features 415. The intermediate features 415 are then down-sampled using a down-sampling layer 420 such that down-sampled features 425 have a resolution less than the initial resolution and a number of channels greater than the initial number of channels.

This process is repeated multiple times, and then the process is reversed. That is, the down-sampled features 425 are up-sampled using up-sampling process 430 to obtain up-sampled features 435. The up-sampled features 435 can be combined with intermediate features 415 having a same resolution and number of channels via a skip connection 440. These inputs are processed using a final neural network layer 445 to produce output features 450. In some cases, the output features 450 have the same resolution as the initial resolution and the same number of channels as the initial number of channels.

In some cases, U-Net 400 takes additional input features to produce conditionally generated output. For example, the additional input features could include a vector representation of an input prompt. The additional input features can be combined with the intermediate features 415 within the neural network at one or more layers. For example, a cross-attention module can be used to combine the additional input features and the intermediate features 415. Embodiments of the image generation model described herein may combine anchor features in a similar manner, but instead of adding the influence of the anchor features, embodiments may subtract the influence. This can be achieved by computing attention weights for the anchor features and then subtracting the resulting weighted features from the intermediate features 415. By doing so, the model reduces the presence of elements associated with the anchor features in the generated output.

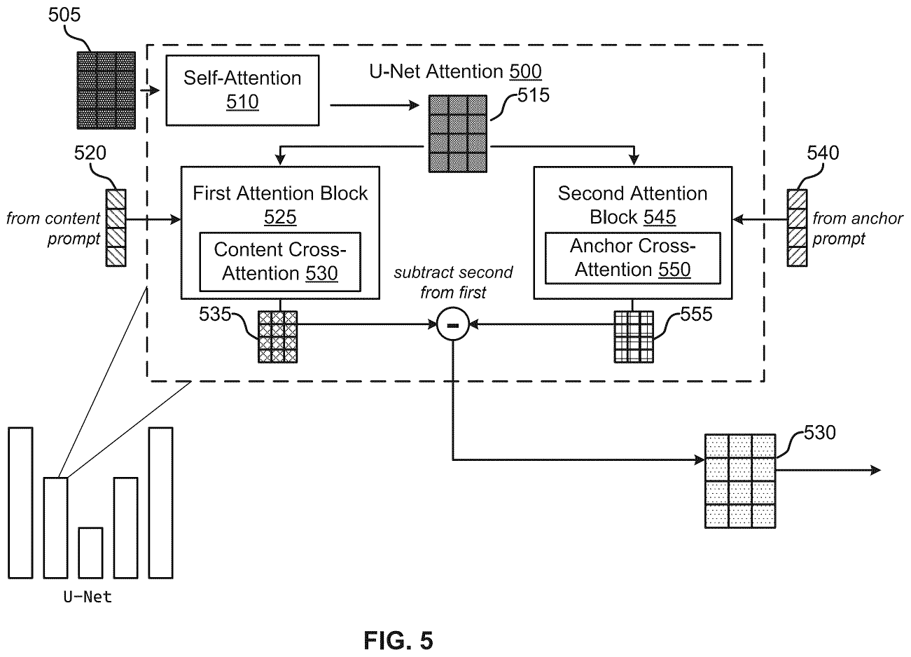

FIG. 5 shows an example of first and second attention blocks 545 according to aspects of the present disclosure. The example shown includes U-Net attention 500, initial query vector 505, self-attention 510, query vector 515, content features 520, first attention block 525, first attention output 535 (condition term), anchor features 540, second attention block 545, second attention output 555 (anchor term), and adjusted query vector 560.

The first attention output 535 can be a tensor or vector representing the target condition (i.e., a desired image element), whereas second attention output 555 can be a tensor or vector representing the anchor condition (i.e., an undesired image element). The U-Net is the same as or similar to the U-Net architecture described with reference to FIG. 4. U-Net attention 500 refers to specifically the blocks of the U-Net that are configured to perform attention operations.

In this example, U-Net attention 500 receives an initial query vector 505, which can represent either the initial noise map or the output from a previous generative step. Self-attention 510 processes the initial query vector 505 to produce query vector 515.

Query vector 515 is then passed to both first attention block 525 and second attention block 545. First attention block 525 uses content cross-attention 530 to combine query vector 515 with content features 520, which are derived from a text prompt describing desired elements in the generated image. For example, a text encoder as described with reference to FIG. 2 may generate content features 520 from a target prompt. First attention block 525 thereby generates first attention output 535 (condition term), which emphasizes the inclusion of these desired elements.

Second attention block 545 uses anchor cross-attention 550 to integrate query vector 515 with anchor features 540, representing elements to be excluded from the image. This results in second attention output 555 (anchor term), which, when subtracted from first attention output 535 reduces the influence of these undesired elements. In some embodiments, first attention block 525 and second attention block 545 share the same model parameters. In these cases, first attention block 525 is run first, and its output, first attention output 535, is saved. Second attention block 545 is then run using the same parameters, and its output, second attention output 555, is subtracted from first attention output 535 to produce adjusted query vector 560. In other embodiments, first attention block 525 and second attention block 545 have different sets of parameters, allowing each block to independently process query vector 515 with content features 520 and anchor features 540, respectively.

The combined outputs of these two attention blocks, first attention output 535 and second attention output 555, are combined by subtracting second attention output 555 from first attention output 535. This subtraction produces adjusted query vector 560, which incorporates both the inclusion of desired features and the exclusion of undesired features. Adjusted query vector 560 is then either fed to the next generative iteration if the reverse diffusion process has not yet completed, or it is decoded to obtain the final synthetic image.

### Generating Images Using Anchor Prompts

FIG. 6 shows a diffusion process 600 according to aspects of the present disclosure. In some examples, diffusion process 600 describes an operation of the image generation model 230 described with reference to FIG. 2, such as the reverse diffusion process 340 of guided diffusion model 300 described with reference to FIG. 3.

As described above with reference to FIG. 3, using a diffusion model can involve both a forward diffusion process 605 for adding noise to an image (or features in a latent space) and a reverse diffusion process 610 for denoising the images (or features) to obtain a denoised image. The forward diffusion process 605 can be represented as q(xₜ|xₜ₋₁), and the reverse diffusion process 610 can be represented as p(xₜ₋₁|xₜ). In some cases, the forward diffusion process 605 is used during training to generate images with successively greater noise, and a neural network is trained to perform the reverse diffusion process 610 (i.e., to successively remove the noise).

In an example forward process for a latent diffusion model, the model maps an observed variable x, (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 610, the model begins with noisy data x_{T}, such as a noisy image 615 and denoises the data to obtain the p(xₜ₋₁|xₜ). At each step t−1, the reverse diffusion process 610 takes xₜ, such as first intermediate image 620, and t as input. Here, t represents a step in the sequence of transitions associated with different noise levels, The reverse diffusion process 610 outputs xₜ₋₁, such as second intermediate image 625 iteratively until x_{T} reverts back to x₀, the original image 630. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 3 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 4 )$$

where p(x_{T})=N(x_{T}; 0, 1) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and x represents the generated image with high image quality.

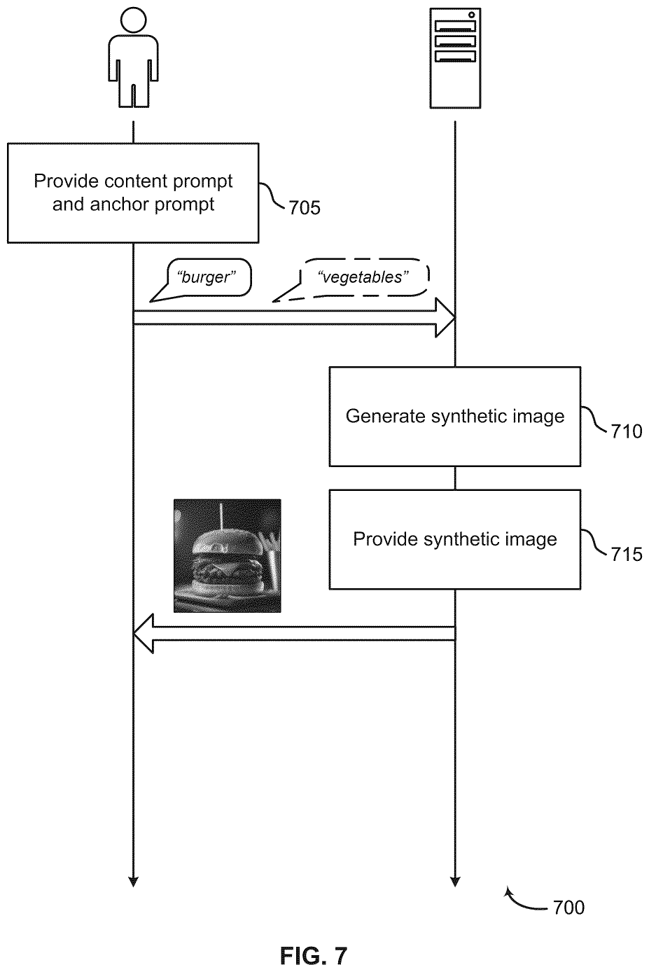

FIG. 7 shows an example of a method 700 for providing a custom image to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 705, a user provides a content prompt (also referred to as a “target prompt” herein) and an anchor prompt. The user may do so via a user interface as described above with reference to FIG. 2. The content prompt describes elements the user wishes to include in a generated image (e.g., “burger” in this example), and the anchor prompt describes elements the user wishes to exclude in the generated image (e.g., “vegetables” in this example). In some cases, the user provides a combined prompt that includes desired and undesired elements, and the system processes the combined prompt using a language model to obtain the content prompt and the anchor prompt.

At operation 710, the system generates a synthetic image. The operations of this step may be performed by an image generation model as described with reference to FIG. 2. The image generation model may, for example, perform a reverse diffusion process as described with reference to FIG. 6. The image generation model may incorporate desired features from the content prompt and exclude features from the anchor prompt by performing the cross-attention operations described with reference to FIG. 5.

At operation 715, the system provides the synthetic image. The system may do so via the user interface as described above. In some embodiments, the system prompts the user for additional edits, and regenerates the synthetic image based on the additional edits. In this way, embodiments can generate a synthetic image including desired elements and excluding desired elements for a user, without needing multiple reverse diffusion passes.

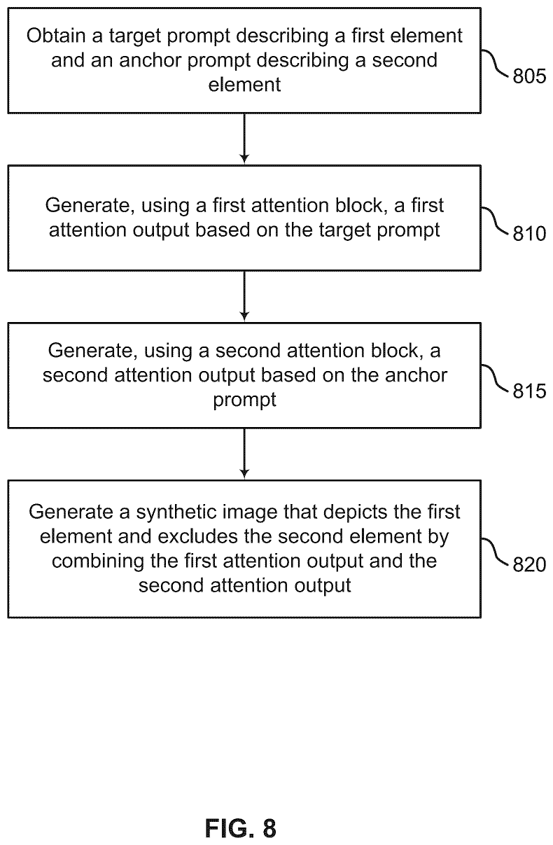

FIG. 8 shows an example of a method 800 for generating an image that depicts a first element and excludes a second element according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains a target prompt describing a first element and an anchor prompt describing a second element. In some cases, the operations of this step refer to, or may be performed by, a user interface as described with reference to FIG. 2. The prompts may be provided by a user interacting with a GUI of the user interface.

At operation 810, the system generates, using a first attention block, a first attention output based on the target prompt. In some cases, the operations of this step refer to, or may be performed by, an image generation model as described with reference to FIG. 2. The first attention output may include attention weights and weighted features derived from content features associated with the target prompt.

At operation 815, the system generates, using a second attention block, a second attention output based on the anchor prompt. In some cases, the operations of this step refer to, or may be performed by, an image generation model as described with reference to FIG. 2. The second attention output may include attention weights and weighted features derived from anchor features associated with the anchor prompt.

At operation 820, the system generates, using the image generation model, a synthetic image that depicts the first element and excludes the second element by combining the first attention output and the second attention output. The system may combine the first attention output and the second attention output according to the pipeline described with reference to FIG. 5.

FIG. 9 is a flow diagram depicting an algorithm as a step-by-step procedure 900 in an example implementation of operations performable for training a machine-learning model. In some embodiments, the procedure 900 describes an operation of the training component 245 described for configuring the image generation model 230 as described with reference to FIG. 2. The procedure 900 provides one or more examples of generating training data, use of the training data to train a machine-learning model, and use of the trained machine-learning model to perform a task.

To begin in this example, a machine-learning system collects training data (block 902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 904) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 906). Initialization of the machine-learning model includes selecting a model architecture (block 908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 910). The loss function is utilized to measure a difference between an output of the machine-learning model (i.e., predictions) and target values (e.g., as expressed by the training data) to be used to train the machine-learning model. Additionally, an optimization algorithm is selected (912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 914) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the procedure 900 continues training of the machine-learning model using the training data (block 918) in this example.

If the stopping criterion is met (“yes” from decision block 920), the trained machine-learning model is then utilized to generate an output based on subsequent data (block 922). The trained machine-learning model, for instance, is trained to perform a task as described above and therefore, once trained is configured to perform that task based on subsequent data received as an input and processed by the machine-learning model.

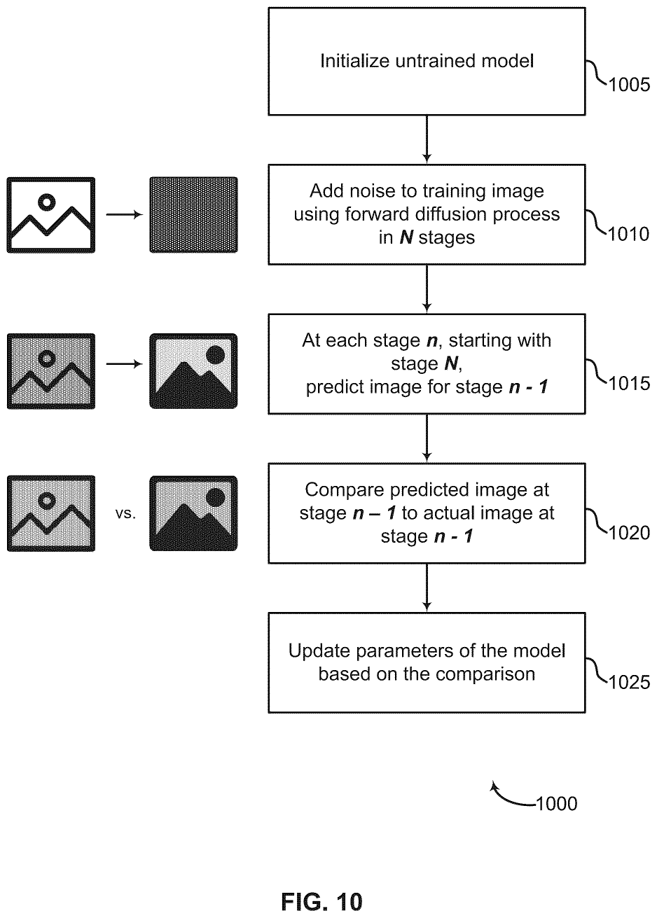

FIG. 10 shows an example of a method 1000 for training a diffusion model according to aspects of the present disclosure. In some embodiments, the method 1000 describes an operation of the training component 245 described for configuring the image generation model 230 as described with reference to FIG. 2. The method 1000 represents an example for training a reverse diffusion process as described above with reference to FIG. 10. In some examples, these operations are performed by a system including a processor executing a set of codes to control functional elements of an apparatus, such as the guided diffusion model described in FIG. 1.

Additionally or alternatively, certain processes of method 1000 may be performed using special-purpose hardware. Generally, these operations are performed according to the methods and processes described in accordance with aspects of the present disclosure. In some cases, the operations described herein are composed of various substeps or are performed in conjunction with other operations.

At operation 1005, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1010, the system adds noise to a training image using a forward diffusion process in N stages. In some cases, the training image may be generated by a teacher model as described above with reference to FIG. 2. In some cases, the forward diffusion process is a fixed process where Gaussian noise is successively added to an image. In latent diffusion models, the Gaussian noise may be successively added to features in a latent space.

At operation 1015, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some embodiments, the noise prediction may be conditioned based on content features and anchor features extracted from a caption associated with the ground truth image. In some cases, an original image is predicted at each stage of the training process.

At operation 1020, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1025, the system updates parameters of the model based on the comparison. For example, parameters of a U-Net may be updated using gradient descent. Time-dependent parameters of the Gaussian transitions can also be learned.

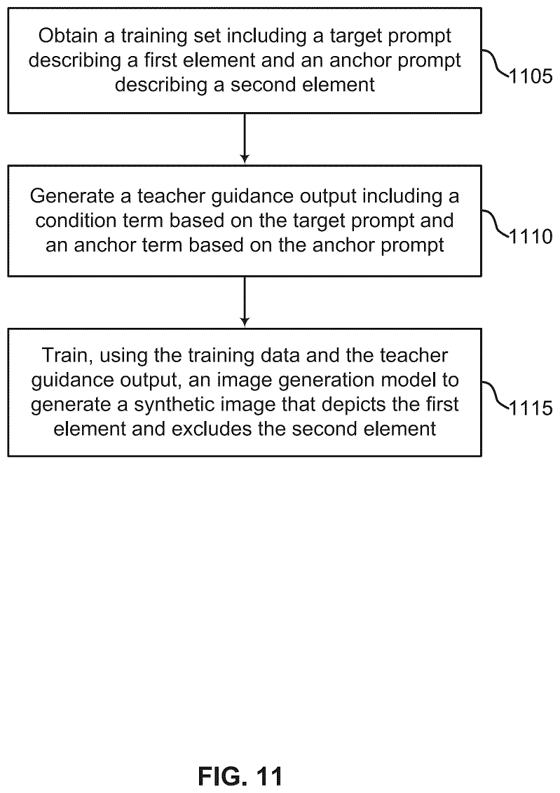

FIG. 11 shows an example of a method 1100 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1105, the system obtains a training set including a target prompt describing a first element and an anchor prompt describing a second element. In some cases, the operations of this step refer to, or may be performed by, a training component as described with reference to FIG. 2.

At operation 1110, the system generates, using a teacher model a teacher guidance output that includes a condition term based on the target prompt and an anchor term based on the anchor prompt. In some embodiments, these terms are obtained from the denoising prediction of the teacher model, which involves running the entire U-Net during a generative iteration to generate the condition and anchor terms. In some embodiments, the condition term and anchor term are obtained directly from the cross-attention layers, where the condition term represents the influence of content features added to the query vector, and the anchor term represents the influence of anchor features subtracted from the query vector.

At operation 1115, the system trains, using the training data and the teacher guidance output, an image generation model to generate a synthetic image that depicts the first element and excludes the second element. In some cases, the operations of this step refer to, or may be performed by, a training component as described with reference to FIG. 2. The system may train the image generation model according to the methods described with reference to FIG. 10.

### Results

FIG. 12 shows an example of results from a teacher model and an image generation model according to aspects of the present disclosure. The example shown includes parent model output with target prompt 1200, parent model output with target prompt and anchor prompt 1205, student model output with target prompt 1210, and student model output with target prompt and anchor prompt 1215.

In this example, a target prompt including “hamburger” is input into both a teacher model and a student model. The right column including parent model output with target prompt and anchor prompt 1205 and student model output with target prompt and anchor prompt 1215 additionally includes an anchor prompt with the word “vegetables.” As shown in the example, both parent model output with target prompt 1200 with student model output with target prompt 1210 generate an image of a hamburger with vegetables including, for example, lettuce and tomatoes.

When the anchor prompt including “vegetables” is added, both the student model and the parent model generate images depicting a hamburger without vegetables. For example, student model output with target prompt and anchor prompt 1215 removes the lettuce and tomato depicted in student model output with target prompt 1210. According to some aspects, the student model considers the anchor features only in the cross-attention layers of its architecture. As a result, the student model runs approximately twice as fast as the CFG-based parent model, which processes the entire U-Net for each external condition.

FIG. 13 shows an example of a computing device 1300 according to aspects of the present disclosure. The example shown includes computing device 1300, processor(s) 1305, memory subsystem 1310, communication interface 1315, I/O interface 1320, user interface component(s), and channel 1330.

In some embodiments, computing device 1300 is an example of, or includes aspects of, an image processing apparatus as described in FIGS. 1 and 2. In some embodiments, computing device 1300 includes one or more processors 1305 are configured to execute instructions stored in memory subsystem 1310 to obtain a target prompt describing a first element and an anchor prompt describing a second element; generate, using a first attention block of an image generation model, a first attention output based on the target prompt; generate, using a second attention block of the image generation model, a second attention output based on the anchor prompt; and generate, using the image generation model, a synthetic image that depicts the first element and excludes the second element by combining the first attention output and the second attention output.

According to some aspects, computing device 1300 includes one or more processors 1305. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating systems. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or via hardware components controlled by the I/O controller.

According to some aspects, user interface component(s) 1325 enable a user to interact with computing device 1300. In some cases, user interface component(s) 1325 include an audio device, such as an external speaker system, an external display device such as a display screen, an input device (e.g., a remote-control device interfaced with a user interface directly or through the I/O controller), or a combination thereof. In some cases, user interface component(s) 1325 include a GUI.

Accordingly, the present disclosure includes the following aspects.

A method for image generation is described. One or more aspects of the method include obtaining a target prompt describing a first element and an anchor prompt describing a second element; generating, using a first attention block of an image generation model, a first attention output based on the target prompt; generating, using a second attention block of the image generation model, a second attention output based on the anchor prompt; and generating, using the image generation model, a synthetic image that depicts the first element and excludes the second element by combining the first attention output and the second attention output.

Some examples of the method, apparatus, non-transitory computer readable medium, and system further include obtaining a preliminary prompt. Some examples further include extracting the target prompt and the anchor prompt from the preliminary prompt. In some aspects, the second attention output is based on the target prompt and the anchor prompt. Some examples of the method, apparatus, non-transitory computer readable medium, and system further include obtaining a query vector, wherein the first attention output and the second attention output are generated based on the query vector.

Some examples of the method, apparatus, non-transitory computer readable medium, and system further include generating a preliminary image, wherein the first attention output and the second attention output are generated based on the preliminary image. The preliminary image may be, for example, a reference image, while the synthetic image is content related to the reference image.

Some examples of the method, apparatus, non-transitory computer readable medium, and system further include obtaining a noise input. Some examples further include generating a guidance output based on the first attention output and the second attention output. Some examples further include denoising the noise input based on the guidance output. In some aspects, the image generation model is trained based on a teacher model that computes a classifier free guidance (CFG) based on a condition term and an anchor term.

A method for image generation is described. One or more aspects of the method include obtaining a training set including a target prompt describing a first element and an anchor prompt describing a second element; generating, using a teacher model, a teacher guidance output including a condition term based on the target prompt and an anchor term based on the anchor prompt; and training, using the training data and the teacher guidance output, an image generation model to generate a synthetic image that depicts the first element and excludes the second element.

In some aspects, the training set includes a training image including the first element and excluding the second element. Some examples of the method, apparatus, non-transitory computer readable medium, and system further include generating, using the image generation model, a guidance output based on the target prompt and the anchor prompt. Some examples further include comparing the guidance output to the teacher guidance output.

Some examples of the method, apparatus, non-transitory computer readable medium, and system further include generating, using a first attention block of the image generation model, a first attention output based on the target prompt. Some examples further include generating, using a second attention block of the image generation model, a second attention output based on the anchor prompt. In some aspects, the teacher guidance output comprises a noise prediction. Some examples of the method, apparatus, non-transitory computer readable medium, and system further include initializing parameters of the image generation model based on the teacher model.

An apparatus for image generation is described. One or more aspects of the apparatus include a memory component; a processing device coupled to the memory component, the processing device configured to perform operations comprising: generating, using a first attention block of an image generation model, a first attention output based on a target prompt, wherein the target prompt describes a first element; generating, using a second attention block of the image generation model, a second attention output based on an anchor prompt, wherein the anchor prompt describes a second element; and generating, using the image generation model, a synthetic image that depicts the first element and excludes the second element by combining the first attention output and the second attention output.

Some examples of the apparatus, system, and method further include a text encoder configured to encode the target prompt and the anchor prompt to obtain a target text embedding and an anchor text embedding, respectively. Some examples of the apparatus, system, and method further include a teacher model. Some examples further include a training component configured to train the image generation model based on the teacher model. In some aspects, the image generation model is initialized based on the teacher model.

In some aspects, the image generation model comprises a diffusion model. In some aspects, the first attention block and the second attention block operate in parallel during a single pass of the image generation model. Some examples of the apparatus, system, and method further include a user interface configured to obtain the target prompt and the anchor prompt.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a target prompt describing a first element and an anchor prompt describing a second element;
generating, using a first attention block of an image generation model, a first attention output based on the target prompt;
generating, using a second attention block of the image generation model, a second attention output based on the anchor prompt; and
generating, using the image generation model, a synthetic image that depicts the first element and excludes the second element by combining the first attention output and the second attention output.

2. The method of claim 1, wherein obtaining the target prompt and the anchor prompt comprises:
obtaining a preliminary prompt; and
extracting the target prompt and the anchor prompt from the preliminary prompt.

3. The method of claim 1, further comprising:
obtaining a query vector, wherein the first attention output and the second attention output are generated based on the query vector.

4. The method of claim 1, further comprising:
generating a preliminary image, wherein the first attention output and the second attention output are generated based on the preliminary image.

5. The method of claim 1, wherein:
the second attention output is based on the target prompt and the anchor prompt.

6. The method of claim 1, wherein generating the synthetic image comprises:
obtaining a noise input;
generating a guidance output based on the first attention output and the second attention output; and
denoising the noise input based on the guidance output.

7. The method of claim 1, wherein:
the image generation model is trained based on a teacher model that computes a classifier free guidance (CFG) based on a condition term and an anchor term.

8. A method of training a machine learning model, the method comprising:
obtaining a training set including a target prompt describing a first element and an anchor prompt describing a second element;
generating, using a teacher model, a teacher guidance output including a condition term based on the target prompt and an anchor term based on the anchor prompt; and
training, using the training set and the teacher guidance output, an image generation model to generate a synthetic image that depicts the first element and excludes the second element.

9. The method of claim 8, wherein:
the training set includes a training image including the first element and excluding the second element.

10. The method of claim 8, wherein training the image generation model comprises:
generating, using the image generation model, a guidance output based on the target prompt and the anchor prompt; and
comparing the guidance output to the teacher guidance output.

11. The method of claim 10, wherein generating the guidance output comprises:
generating, using a first attention block of the image generation model, a first attention output based on the target prompt; and
generating, using a second attention block of the image generation model, a second attention output based on the anchor prompt.

12. The method of claim 8, wherein:
the teacher guidance output comprises a noise prediction.

13. The method of claim 8, further comprising:
initializing parameters of the image generation model based on the teacher model.

14. A system comprising:
a memory component; and
a processing device coupled to the memory component, the processing device configured to perform operations comprising:
generating, using a first attention block of an image generation model, a first attention output based on a target prompt, wherein the target prompt describes a first element;
generating, using a second attention block of the image generation model, a second attention output based on an anchor prompt, wherein the anchor prompt describes a second element; and
generating, using the image generation model, a synthetic image that depicts the first element and excludes the second element by combining the first attention output and the second attention output.

15. The system of claim 14, further comprising:
a text encoder configured to encode the target prompt and the anchor prompt to obtain a target text embedding and an anchor text embedding, respectively.

16. The system of claim 14, further comprising:
a teacher model; and
a training component configured to train the image generation model based on the teacher model.

17. The system of claim 16, wherein:
the image generation model is initialized based on the teacher model.

18. The system of claim 14, wherein:
the image generation model comprises a diffusion model.

19. The system of claim 14, wherein:
the first attention block and the second attention block operate in parallel during a single pass of the image generation model.

20. The system of claim 14, further comprising:
a user interface configured to obtain the target prompt and the anchor prompt.
